(19) United States
(12) Patent Application Publication
(10) Pub. No.: US 2010/0285192 A1
(43) Pub. Date: Nov. 11, 2010

(54) METHOD FOR FILTERING A LIQUID

(75) Inventors: Daniel Daoust, Chaurmont Gistoux (BE); Jean-Jacques Biebuyck, Rixensart (BE); Michel Sclavons, Woluwe-Saint-Lambert (BE); Maxime Libouton, Ath (BE); Laurence Van Nedervelde, Braine-Le Comte (BE)

Correspondence Address: KNOBBE MARTENS OLSON & BEAR LLP, 2040 MAIN STREET, FOURTEENTH FLOOR, IRVINE, CA, 92614, US

(73) Assignees: Universite Catholique de Louvain, Louvain-la-Neuve (BE); Meurice R & D, Bruxelles (BE)

(21) Appl. No.: 12/863,660

(22) PCT Filed: Jan. 29, 2009
(86) PCT No.: PCT/EP09/51013

§ 371 Date: Jul. 20, 2010

(30) Foreign Application Priority Data
Jan. 29, 2008 (EP) 08150800.4

(51) Int. Cl. C12H 1/00

(52) U.S. Cl. 426/422

(57) ABSTRACT

The present invention is directed to a method for filtering a liquid, such as beer, comprising carrying out the filtration of said liquid in the presence of a filter aid, wherein said filter aid essentially comprises porous or non porous polyolefin particles having a specific mass less than 1000 kg/m3 and having an at least partly oxidized outer surface, whereby said outer surface is provided with nodular structures.

### FIELD OF THE INVENTION

The present invention relates to a method for filtering a liquid, such as beer using, preferably at the end of the cold maturation. The method according to the invention is particularly suitable for the clarification step of brewing process.

### BACKGROUND OF THE INVENTION

In the brewing process, filtration and stabilization are very important steps to render beer brilliant and to provide beers with longer shelf life. The object of the clarification step is to remove all yeasts and colloidal particles in suspension in the beer at the end of the cold maturation. The standard values reached are clarity less than 0.5° EBC (European Brewing Convention) and micro-organism content less than five yeasts per liter. On the other hand, the stabilization step allows removing specific protein and polyphenols compounds responsible for haze formation during storage.

Filtration in breweries is most commonly accomplished by the use of filter aids, which form incompressible and porous filter beds, allowing a relatively free flow of beer while retaining particles to be eliminated.

Filtration using filter aid is a two step operation. First, a thin protective layer of filter aid, called the pre-coat, is built up on the filter septum (cloth) by re-circulating a filter aid slurry. This step allows to prevent the filter septum from becoming clogged by impurities, to give immediate clarity and to facilitate cleaning of the septum at the end of the cycle. After pre-coating, small amounts of filter aid (body feed) are regularly added to the liquid to be filtered. As filtering progresses, the filter aid, mixed with the suspended solids from the unfiltered liquid, is deposited on the pre-coat. Thus permeability of the media is maintained during long filtration runs. The filter aid particles, used for pre-coat and body feed, provide countless microscopic channels which entrap suspended impurities but allow liquid to pass through, without clogging. When the filtration cycle is finished, the filter cake is blown off from the filter and is removed as slurry.

Different types of filters can be used with filter aids, usually kieselguhr or perlite, such as sheet plate filter, candle filter, vertical and horizontal leaf filters.

Up to now, kieselguhr is the most filter aid used for the clarification step. However, despite satisfying results, kieselguhr seems to present drawbacks such as health hazards and increasing costs for disposal. Attempts have been made to reach the same level of performance (haze value around 0.5° EBC) by using synthetic materials which can be regenerated.

To achieve beer stabilization, it is necessary to remove either the protein or the polyphenol or both from the beer during the cold maturation or filtration steps, by using complexing agents such as crosslinked-polyvinylpolypyrrolidone, gallotannin, silica gel or Na-silicate. EP 1 201 288 discloses a filter aid having a specific mass less than 1000 kg/m3 and wherein the outer surface of the particles of the filter aid have been oxidized by putting said particles in a KOCl and/or NaOCl solution. The particles of the filter aid have their hydrophilicity increased by this chemical treatment.

U.S. Pat. No. 6,117,459 discloses incompressible synthetic or natural polymer grains having a sphericity coefficient between 0.6 and 0.9 and a density of approximately 1200 kg/m3. Polymers mainly used in this patent are polyamides such as Nylon®.

EP 1 283 864 discloses a process for removing soluble organic compounds such as TCA by contacting the beverage with a synthetic aliphatic polymer chemically treated to contain acid and hydroxyl group.

EP 1 751 266 relates to a method for preparing and/or filtering a liquid, which contains haze sensitive proteins. The method comprises the step of adding one or more protein-complexing agent capable of forming complexes that can be selectively retained during filtration, with at least some of the haze sensitive proteins, when using synthetic polymers or derivatives of silica as filter aid. Polymers mainly used in this patent application are polyamides such as Nylon®.

U.S. Pat. No. 6,736,981 discloses the use of popcorn polymers that contain copolymerized, α,β-monoethylenically unsaturated carboxylic acids and styrene or styrene derivatives.

For beer filtration, synthetic polymers are usually used as filter aid in a candle filtration device. They form a granular media or a filter cake. The porosity of filtration media, granular media or filter cakes formed by synthetic polymers has a dramatic influence on the filtration step and the final haze value. As know in the art the porosity of media will depend on the shape of the particles used as filter aid.

For example spherical or quasi-spherical particles form a filter cake having low porosity. Beer obtained with such materials is almost bright but the pressure inside a candle filtration device will dramatically increase and thus use of such materials will result in a less efficient brewing process. Polyamide particles are not spherical but look like gravels with straight surface without defect at the outer surface and form also a filter cake having low porosity with similar drawbacks as previously mentioned.

With regard to prior art, it is clear that there is a need to find a material having features allowing to obtain bright beer while maintaining an efficient pressure within the filtering device.

The present invention aims to provide a solution to at least some of the above mentioned problems, in order to give rise to bright beer while maintaining efficient pressure within a filtering device. The invention also aims to provide a liquid with improved haze value and a haze value that reaches a level close to the level reached when kieselguhr is used.

### SUMMARY OF THE INVENTION

In a first aspect, the invention provides a method for filtering a liquid, such as beer, said method comprising carrying out the filtration of said liquid in the presence of a filter aid, wherein said filter aid essentially comprises porous or non porous polyolefin particles having a specific mass less than 1000 kg/m³ and having an at least partly oxidized outer surface, whereby said outer surface is provided with nodular structures.

Preferably, the present invention provides a method for filtering beer, comprising carrying out the filtration of said beer in the presence of a filter aid, wherein said filter aid essentially comprises porous or non porous UHMWPE particles having a specific mass less than 1000 kg/m³ and having an at least partly oxidized outer surface, whereby said outer surface is provided with nodular structures. In an embodiment, said UHMWPE particles having an at least partly oxidized outer surface, said outer surface being provided with nodular structures is selected from the group consisting of UH-1900, UH-1700, UH-1500, UH-1130, UH-1250, UH-1080 and UH-1045 from Inhance/Fluoro-Seal, Ltd., Houston, Tex., more preferably from UH-1700, UH-1500, UH-1130, UH-1250, UH-1080.

The present method comprises the step of contacting a liquid with filter aid particles having an outer surface at least partly oxidized by a surface treatment increasing their hydrophilicity, and having their specific surface area increased by the presence of nodular structures at their outer surface.

According to an embodiment of said method, said polyolefin particles form a filtration medium, a granular medium or a filter cake having a porosity of at least 0.5.

In an embodiment, said polyolefin particles have a size distribution which is defined by an average diameter comprised between 1 and 500 μm, preferably between 20 and 300 μm. Yet more preferably said polyolefin particle is UHMWPE having a size distribution which is defined by an average diameter comprised between 20 and 300 μm. Preferably the filtered liquid has a haze value of less than 0.7 EBC when said filter aid is used in combination with a complexing agent selected from PVPP, gallotannin or a protein complexing agent.

In an embodiment said filtration is performed in a filtration device, preferably a candle filtration device. More preferably, said filter aid is provided in said device as a pre-coating material and/or as body feed simultaneously with an agent selected from PVPP, gallotannin or a protein complexing agent preferably to achieve clarification and stabilization in one step.

The filter aid presently used differs from filter aid prior art due to a particular structure increasing its specific surface area and therefore increasing the porosity of a filtration media, a granular media or a filter cake formed when using a filter aid as defined herein.

The term “polyolefin particles” as used in the present invention refers to polymers or copolymers of ethylene, propylene, butene, methylpentene or any mixtures thereof. The polyolefin particles can be porous or not. The term “porous” as used herein refers to polyolefin particles having internal channels, opened or not. With such type of particles both porosity of the particles and porosity of filtration media formed by said particles increases. Yeast and colloidal particles can go through and be trapped or retained within the channels depending on the size of the particles.

Unless otherwise provided, the term “haze” refers to the haze measured at 90°. The haze is usually due to fine particles such as proteins-polyphenols particles.

The outer surface of such particles is characterized by the presence of irregular shaped structures such as “nodular structures” or “excrescences” which increase the specific surface area of said polyolefin particles. In addition, the outer surface of the polyolefin particles has been submitted to a surface treatment increasing the hydrophilicity of said particles. Such surface treatment can be a chemical treatment such as oxidation.

In a preferred embodiment, the polyolefin particles form a filtration media, a granular medium or a filter cake wherein the porosity of the media is at least 0.5 and preferably at least 0.6. The invention also relates to a filtration medium, a granular medium or a filter cake comprising a filter aid consisting of a porous or non porous polyolefin particles having a specific mass less than 1000 kg/m³ and having an at least partly oxidized outer surface, whereby said outer surface is provided with nodular structures, wherein the porosity of the media is at least 0.5 and preferably at least 0.6.

In another aspect, the invention provides a method for producing a filter aid as described herein comprising the steps of:
providing porous or non porous polyolefin particles having nodular structure on the outer surface thereof,
treating the outer surface of said particles, preferably by plasma treatment, chemical oxidation or a oxyfluorination process, and
optionally adding one or more complexing agents as defined herein to said filter aid.

It is a further object of the invention to provide for the use a filter aid for filtering a liquid, preferably beer, wherein said filter aid preferably consists essentially of polyolefin particles having a specific mass less than 1000 kg/m³ and an outer surface at least partly oxidized by a surface treatment increasing their hydrophilicity, wherein said porous or non porous polyolefin particles have their specific surface area increased by the presence of nodular structures at their outer surface.

It is a fourth object of the invention to use a filter aid as disclosed in the present invention in a filtration device such as a candle filtration device, a sheet plate filter or vertical and horizontal leaf filters, and preferably a candle filtration device.

It is a fifth object of the invention to use filter aid as disclosed in the present invention in a filtration device, as a pre-coating material and/or as ‘body feed’ simultaneously with one or more complexing agent(s) as defined herein to achieve clarification and stabilization in one step. The term “body feed” is intended to refer to small amounts of filter aid that are regularly added to the liquid to be filtered. In an example of beer filtration, the amounts of filter aid added to the liquid to be filtered may be comprised between 0.5 and 2.5 g/L, depending on beer quality and/or the filtration device.

In a further aspect, the invention provides a filtration device, preferably a candle filtration device, comprising a filter aid as described herein. In particular, the invention provides a candle filtration device comprising one or more candles provided with a pre-coat essentially comprising a filter aid as described herein.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE FIGURES

FIG. 1 represents a view, obtained by scanning electron microscopy, of the outer surface of oxidized polyethylene particles presenting nodular structures of a filter aid for use according to the invention.

FIG. 2 represents a view, obtained by scanning electron microscopy, of the outer surface of spherical (smooth) and oxidized polyethylene particles of a filter aid.

FIG. 3 represents a view, obtained by scanning electron microscopy, of the outer surface of oxidized polyethylene particles of a prior art filter aid as disclosed in EP 1 201 288.

FIG. 4 shows the size distribution of filter aid particles.

FIG. 5 shows the haze of a filtered beer at 90° and 25° as function of filtered beer volume when using oxidized polyethylene having nodular structures at the outer surface as represented in FIG. 1 in presence or not of a complexing agent.

FIG. 6 shows the pressure difference within a filtration device as function of filtered beer volume when using oxidized polyethylene having nodular structures at the outer surface as represented in FIG. 1 in presence or not of a complexing agent.

FIG. 7 shows the haze of a filtered beer at 90° and 25° as function of filtered beer volume when using spherical oxidized high density polyethylene as represented in FIG. 2 in presence or not of a complexing agent.

FIG. 8 shows the pressure difference within the filtration device as function of filtered beer volume when using spherical oxidized high density polyethylene as represented in FIG. 2 in presence or not of complexing agent.

FIG. 9 shows the haze of a filtered beer at 90° and 25° and pressure difference within the filtration device as function of filtered beer volume when using a prior filter aid as disclosed EP 1 201 288.

FIG. 10 shows the pressure difference within the filtration device as function of filtered beer volume when using oxidized polyethylene, having nodular structures at the outer surface, in presence or not of complexing agents such as Brewtan® and PVPP.

FIG. 11 shows the haze of a filtered beer at 90° and 25° as function of filtered beer volume when using oxidized polyethylene, having nodular structures at the outer surface, in presence or not of complexing agents such as Brewtan® and PVPP.

### DETAILED DESCRIPTION OF THE INVENTION

As used herein the term “comprising” should not be interpreted as being restricted to the means listed thereafter; i.e. it does not exclude other elements or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention provides a method for filtering a liquid, preferably beer, comprising carrying out the filtration of said liquid in the presence of a filter aid, wherein said filter aid essentially comprises porous or non porous polyolefin particles having a specific mass less than 1000 kg/m³ and having an at least partly oxidized outer surface, whereby said outer surface is provided with nodular structures.

In particular, the invention uses a filter aid for filtering liquid such as beer wherein said filter aid consists essentially of porous or non porous polyolefin particles having a specific mass less than 1000 kg/m³ and an outer surface at least partly oxidized by a surface treatment increasing their hydrophilicity, wherein said porous or non porous polyolefin particles have their specific surface area increased by the presence of nodular structures at the outer surface. Preferably the specific surface area of the polyolefin particles is at least 1 m²/g, preferably at least 1.1 m²/g, yet more preferably at least 1.2 m²/g, yet more preferably at least 1.3 m²/g. Yet more preferably the specific surface area of the oxidized UHMWPE particles is at least 1 m²/g, preferably at least 1.1 m²/g, yet more preferably at least 1.2 m²/g, yet more preferably at least 1.3 m²/g.

In an embodiment, the present invention provides a method for filtering beer, comprising carrying out the filtration of said beer in the presence of a filter aid selected from the group consisting of UH-1900, UH-1700, UH-1500, UH-1130, UH-1250, UH-1080 and UH-1045 from Inhance/Fluoro-Seal, Ltd., Houston, Tex., more preferably from UH-1700 , UH-1500, UH-1130, UH-1250, UH-1080.

In another embodiment, the present invention provides a method for filtering beer, comprising carrying out the filtration of said beer in the presence of a filter aid selected from the group consisting of GUR® UHMW-PE such as GUR 4120®, GUR 4020®, GUR 4150®, GUR 4050®, GUR 1020®, GUR 1050®, GUR 4130®, wherein said GUR® UHMWPE particles are further treated such as to have an at least partly oxidized outer surface.

Filtration is generally accomplished by forcing liquid under pressure through a cloth or screen (septum). The solids to be filtered may be non-rigid, slimy or colloidal in size and occur in most organic and food products. Theoretically the liquid should pass through the opening of the filter cloth and the impurities remain on the cloth. In practice, the finer, suspended solids pass through the coarse openings in the cloth and larger particles remain behind to clog the openings, smear the cloth and slow down or, most likely, stop the flow. In such systems where filtration resistance is high, unwanted solids can be removed efficiently and economically by use of filter powder. The filter powder forms a porous layer on the filter septum, which acts principally as a support for this cake/bed. The filter aid is now the filtering medium that traps the solids to be removed and prevents them from blinding the septum. Use of such filter aid also allows quick and easy cake removal without damage to the cloth.

The present invention is in particular directed to a filtration method of various liquids such as but not limited to beer, wine, soda, cider, or the like. In a preferred embodiment the present invention is directed to a method for filtering beer.

According to one embodiment, the present invention provides a method for filtering a liquid preferably beer using a filter aid comprising, and preferably consisting essentially of porous or non porous polyolefin particles (preferably UHMWPE) having a specific mass less than 1000 kg/m³ and an outer surface at least partly oxidized by a surface treatment increasing their hydrophilicity and wettability, wherein said porous or non porous polyolefin particles have their specific surface area increased by the presence of nodular structures at their outer surface, wherein said specific surface area of the polyolefin particles is at least 1 m²/g, preferably at least 1.1 m²/g, yet more preferably at least 1.2 m²/g, yet more preferably at least 1.3 m²/g, and wherein said particles have a size distribution which is defined by an average diameter comprised between 20 and 300 μm, preferably between 20 and 200 μm, yet more preferably between 20 and 150 μm, yet more preferably between 20 and 100 μm.

The nodular structures at the outer surface of the filter aid, consisting essentially of porous or non porous polyolefin particles, form irregular micro- or nano-pores or micro or nano-void spaces which are able to retain yeast and colloidal particles of the liquid. Therefore, the specific surface area of the filter aid and the porosity of the filtration media, granular media or filter cake formed by said filter aid increase. More in particular, polyolefin particles having “nodular structures” on their outer surface are intended to refer to irregular particles (average size of for instance less than 60 μm, preferably less than 50 μm or less than 40 μm) exhibiting a structure similar to agglomerated nodules, whereby each nodule preferably has a size of between 1 and 10 μm, for example about 1 μm, for example between 2 and 5 μm, for example about 2 μm, and an irregular shape. In one embodiment, the nodular structures on the outer surface of the polyolefin are obtained as a result of the polyolefin synthesis process. Non-limiting examples of suitable processes to obtain said polyolefin particles with nodular structures are described in Birnkraut HW. Synthesis of UHMWPE. In Ultra-High Molecular Weight Polyethylene as a Biomaterial in Orthopedic Surgery. Eds.: Hogrefe & Huber Publishers, 1991. Other suitable processes are described in GB1451292 hereby incorporated by reference. A suitable process is, for example, the Ziegler process, in which compounds of transition metals (in their lower oxidation states) of Groups 4A to 6A of the Periodic System are employed together with organometallic compounds of elements of Groups 1A, 2A and 3B of the Periodic System as catalysts. The synthesis of UHMW polyethylene by Ziegler-Natta Catalysis is described in D. Breslow et al., J. Am. Chem. Soc., 31,81-86 (1959), J. Chien et al., J. Polym. Sci. Polym. Chem., 31, 227-237 (1993), and U. Zucchini et al., J. Molec. Cat., 82, 45-56 (1993), incorporated in their entireties by reference herein. According to another process (c.f U.S. Pat. No. 3,051,993) ultrahigh molecular weight polyethylene can be produced from anhydrous, oxygen-free ethylene in the gas phase, in the presence of supported catalysts containing chromium oxide and alkyl metal. Preferably, the synthesis of nodular polyethylene, comprises using a suspension polymerization of ethylene with a catalyst such as biscyclopentadienyl titanium dichloride, biscyclopentadienylzircomium dichloride, or cyclopentadienyl zirconium trichloride, and a co-catalyst such as trialkylaluminum, soluble in an alkane medium such as heptane or hexane. The trialklyaluminum co-catalysts include triethyl aluminum, tri-isopropylaluminum, and tributylaluminum. The nodular structure of the polyolefin can be formed by the control of the polymerization rate, with use of a particular temperature and catalyst, which affects the particle stability and dynamics of aggregation.

According to the invention, said porous or non porous polyolefin particles can have any shape such as spheres, fibers, filaments or mixture thereof but are not limited to them.

In another preferred embodiment, said filter aid used in said method, comprises polyolefin particles wherein volumic size distribution of the polyolefin particles is defined by an average diameter between 1 and 500 μm, preferably between 10 and 300 μm, preferably between 20 and 300 μm, preferably between 10 and 200 μm, more preferably between 20 and 150 μm, yet more preferably between 20 and 60 μm, yet more preferably between 30 and 60 μm, yet more preferably between 30 and 50 μm. The particle size distribution can be monomodal or plurimodal.

The polyolefin particles used herein have a specific mass less than 1000 kg/m³. Other examples of suitable ranges of particles specific masses according to the present invention may include but are not limited to ranges of 900-1000 kg/m³, 900-990 kg/m³, 950-990 kg/m³, or 900-940 kg/m³.

Preferably said polyolefin is selected from the group comprising polyethylene such as UHMWPE, HMWPE, HDPE, LLDPE, MDPE, LDPE; polypropylene; polybutene, polymethylpentene; ethylene copolymers; or any mixtures thereof. Preferably, the polyolefin particles are made of polyethylene such as UHMWPE, HMWPE, HDPE, LLDPE, MDPE, LDPE or any mixture thereof. More preferably, a filter aid as described herein is provided, wherein said polyolefin particles are made of HDPE or UHMWPE or a mixture thereof.

Preferably, said filter aid is made of UHMWPE particles having an average diameter comprised between 1 and 500 μm, preferably between 10 and 300 μm, preferably between 20 and 200 μm preferably between 10 and 200 μm and more preferably between 20 and 150 μm, yet more preferably between 20 and 60 μm, yet more preferably between 30 and 60 μm, yet more preferably between 30 and 50 μm, and presenting nodules on its surface whereby each nodule has a size of between 1 and 10 μm, for example about 1 μm, for example between 2 and 5 μm, for example about 2 μm.

Yet more preferably said polyolefin particles are made of UHMWPE having an average molecular weight ranging from 1 to 11 million g/mol, preferably 3 to 10.5 million g/mol, yet more preferably from 3 to 5 million g/mol. Yet more preferably said polyolefin particles are made of UHMWPE said polyolefin is UHMWPE from TICONA such as GUR® UHMW-PE such as GUR 4120®, GUR 4020®, GUR 4150®, GUR 4050®, GUR 1020®, GUR 1050®, and GUR 4130®. Said GUR® UHMWPE is further treated such as to have an at least partly oxidized outer surface. Preferably said treatment is plasma treatment, chemical oxidation or oxyfluorination process, more preferably by chemical oxidation or oxyfluorination process.

In an embodiment, said filter aid comprising porous or non porous UHMWPE particles having an at least partly oxidized outer surface, having an outer surface provided with nodular structures, can be commercially available for example from INHANCE™ (Inhance/Fluoro-Seal, Ltd., Houston, Tex.). Suitable filter aid can be for example the INHANCE UH-1000 series particles, such as UH-1900, UH-1700, UH-1500, UH-1130, UH-1250, UH-1080 and UH-1045. INHANCE UH-1000 series particles are surface oxidized UHMWPE particles having nodular structures on the outer surface.

According to the invention, said porous or non porous polyolefin particles can be grafted or modified to introduce functional group of interest able to retain polyphenols or proteins. In an embodiment, said polyolefin particles can be grafted or modified polyethylene particles. Preferably, said polyolefin particles are grafted or modified UHMWPE particles Hydrogen bridge can be formed between the hydroxyl or carbonyl groups of the polyphenols or proteins and the functional group of interest such as hydroxyl, amide or carbonyl groups.

In another embodiment, said polyolefin particles can be regenerated. Preferably said UHMWPE are regenerated. Regeneration as used herein is intended to refer to an operation meant to provide filter aid particles free of stains such as yeast, haze matter, without any modification of their properties; so that the filter aid can be re-used for later filtration runs. The filter aid can be regenerated to its initial form using chemical treatment or enzymatic purification as known in the art. For example, regeneration can be done using a detergent containing potassium hydroxide and sodium hypochlorite. The dirty filter aid is regenerated four times in a 2% solution of the detergent during one hour at 60° C. at a concentration of 150 g/l. The regenerated filter aid gives a same efficiency as a non-regenerated filter aid.

In still another preferred embodiment, the invention uses a filter aid that further comprises a complexing agent. The term “complexing” agent as used herein comprises an agent capable of forming a complex with proteins and/or polyphenols(s). Such complexing agent may be selected from the group comprising crosslinked-polyvinylpolypyrrolidone (PVPP), gallotannin or a protein complexing agent(s) such as tannic acids or Brewtan®. The filter aid can be combined with PVPP, gallotannins such as Brewtan® or other protein complexing agents such as silicate, silica gel, chitosan.

In another embodiment, the polyolefin particles form a filtration medium, a granular medium or a filter cake having a porosity of at least 0.5. Preferably, said filter aid which consists of porous or non porous polyolefin particles forms a filtration medium or a granular medium or a filter cake having a porosity of at least 0.5, preferably at least 0.6.

The porosity (ε) as presently used refers to the amount of empty spaces within the structure of the filtration media. The porosity can be measured as:

ε=1−(ρₐ/ρₛ)

wherein ρₐ is the apparent density of the porous media (g/cm³), ρₛ is the real density of the filter aid particles (g/cm³).

The filter aid for use in the invention can be prepared as described herein. Such production method comprises a step of providing porous or non porous polyolefin particles having nodular structures as defined herein. In a preferred embodiment said polyolefin particles is made of UHMWPE preferably from TICONA N.V. More preferably said polyolefin particles is GUR® (UHMWPE) micropowders from TICONA having an average molecular weight, measured by viscosimetric method, in the range of 3.9 to 10.5 million g/mol.

In another step, the outer surface of the particles as defined herein, such as GUR® (UHMWPE) micropowders from TICONA, is surface treated, preferably by plasma treatment, chemical oxidation or oxyfluorination process. Polyolefin particles have their hydrophilicity increased by having been submitted to a surface treatment. Surface treatment can be an oxidation by techniques known in the art such as chemical oxidation in presence of KOCl, H₂O₂ or NaOCl solution, plasma treatment or oxyfluorination process. This oxidation step allows an increase the wettability of the particle's surfaces for a good clarification of the beer. Preferably said filter aid is UHMWPE wherein the partly oxidized outer surface is obtained by chemical oxidation in the presence of KOCl, H₂O₂ or NaOCl solution, or by plasma treatment or by oxyfluorination process

In an embodiment, the chemical oxidation step may be obtained by reaction of putting said particles in a solution of hypochlorus acid (HClO) and/or its sodium (NaOCl) and/or potassium salts (KOCl) (for example a 15% solution).

In an embodiment, said oxyfluorination can be performed as described in U.S. Pat. No. 4,771,110 or in U.S. Pat. No. 4,833,205, or in U.S. Pat. No. 4,880,879 hereby incorporated by reference. In an embodiment, the polyolefin particles are placed in a reactor and exposed to a reactive mixture of gases, one component of which is fluorine, together with one or more reactive gases and an inert diluent or carrier gas. The treating gas composed of fluorine and oxygen as reactive components in an inert gas carrier, for the purpose of the present invention, should contain at least 1 ppm and up to about 25% by volume elemental fluorine, and 5 ppm to a maximum of 25% elemental oxygen. The molar ratio of O₂/F₂ in the treating gas is not critical and may be preferably in the range of 1:1000 to 200:1. The exposure of the particles to the treating gas should be for a time sufficient to incorporate into the surface layer of the particles from 5 to about 67% by number of fluorine and oxygen atoms, as determined by electron spectroscopy for chemical analysis (ESCA), also called XPS (X-ray photoelectron spectroscopy). Instead of or in addition to oxygen accompanying the fluorine treating gas other reactive gases may be added, such as Cl₂, SO₂, Br₂, BrCl₃, BrCl, CO, and similar gases reacting to generate functional reactive sites in the particle surface layer. The reaction is carried out under conditions such that the polymeric particles come in intimate contact with the gas mixture. This can be accomplished by using a rotating or tumbling reactor, fluidized bed or other suitable means. For example, the oxyfluorination can be performed by treating UHMWPE particles having a particle size in the range of 20 to 150 μm with a gas mixture comprising (by volume) 1% fluorine, 40% sulfur dioxide and 59% nitrogen for thirty minutes, introduced at room temperature. Similarly, the oxyfluorination can be performed by treating UHMWPE particles having a particle size in the range of 20 to 150 μm with a gas mixture comprising (by volume) 1% fluorine, 16% oxygen and 83% nitrogen for 30 minutes.

Optionally the method may comprise the step of adding one or more complexing agents as defined herein to said filter aid.

According to one embodiment, the present invention provides a method for filtering a liquid comprising the step of contacting a liquid with a filter aid comprising or consisting essentially of porous or non porous polyolefin particles having a specific mass less than 1000 kg/m³, and an outer surface at least partly oxidized by a surface treatment increasing their hydrophilicity, wherein said porous or non porous polyolefin particles have their specific surface area increased by the presence of nodular structures at their outer surface, and wherein said nodular structures have an average diameter of 1 to 10 μm, preferably of 1 to 5 μm, preferably of about 1 to 3 μm.

In another embodiment, the method comprises the step of contacting a liquid with a filter aid comprising or consisting essentially of polyolefin particles wherein said polyolefin particles form a filtration media, a granular medium or a filter cake having a porosity of at least 0.5, preferably at least 0.6.

In another embodiment, the method comprises the step of contacting a liquid with a filter aid comprising or consisting essentially of polyolefin particles having particles size distribution defined by an average diameter between 1 and 500 μm, preferably between 10 and 200 μm, more preferably between 20 and 150 μm, preferably between 20 and 60 μm, yet more preferably between 30 and 60 μm, and having nodular structures wherein each nodule has an average diameter of 1 to 10 μm, preferably of 1 to 5 μm, preferably of about 1 to 3 μm. The particle size distribution can be monomodal or plurimodal.

In a preferred embodiment, the method comprises the step of contacting a liquid with a filter aid comprising or consisting essentially of polyolefin particles wherein said polyolefin is selected from the group of polyethylene such as comprising UHMWPE, HMWPE, HDPE, LLDPE, MDPE, LDPE; polypropylene, polybutene, polymethylpentene, ethylene copolymers or mixture thereof, having particles size distribution defined by an average diameter between 1 and 500 μm, preferably between 10 and 200 μm, more preferably between 20 and 150 μm, preferably between 20 and 60 μm, yet more preferably between 30 and 60 μm, and having nodular structures, wherein each nodule has an average diameter of 1 to 10 μm, preferably of 1 to 5 μm, preferably of about 1 to 3 μm. Preferably, the polyolefin particles are selected from the group of polyethylene comprising UHMWPE, HMWPE, HDPE, LLDPE, MDPE, LDPE or mixture thereof, having particles size distribution defined by an average diameter between 20 and 150 μm, preferably between 20 and 60 μm, yet more preferably between 30 and 60 μm, and having nodular structures, wherein each nodule has an average diameter of 1 to 5 μm, preferably of about 1 to 3 μm. More preferably, the polyolefin particles are made of HDPE or UHMWPE or mixture thereof, having particles size distribution defined by an average diameter between 20 and 60 μm, preferably between 30 and 60 μm, and having nodular structures, wherein each nodule has an average diameter of about 1 to 3 μm. Said polyolefin particles have a specific mass less than 1000 kg/m³. Other examples of suitable ranges according to the present invention include but are not limited to 900-1000 kg/m³, 900-990 kg/m³, 950-990 kg/m³, 900-940 kg/m³.

The filter aid for use in the present invention is particularly useful for filtering liquids such as but not limited to beer, wine, soda, or cider. When using the filter aid in combination with a complexing agent as defined herein and for instance PVPP, gallotannin or a protein complexing agent, the filtered liquid has a haze value of less than 0.7 EBC (European Brewing Convention), and preferably less than 0.5 EBC. The Haze value can be measured using techniques well known in the art.

The filter aid for use in the present invention is particularly useful in a candle filtration device. The filter aid for use in the present invention is also useful as pre-coating material and as body feed simultaneously with some complexing agents to achieve clarification and stabilization in one step. It will be clear from the present invention, that the filter aid as defined herein may also by advantageously used for improving other types of filtration processes.

### EXAMPLES

### Filtration test

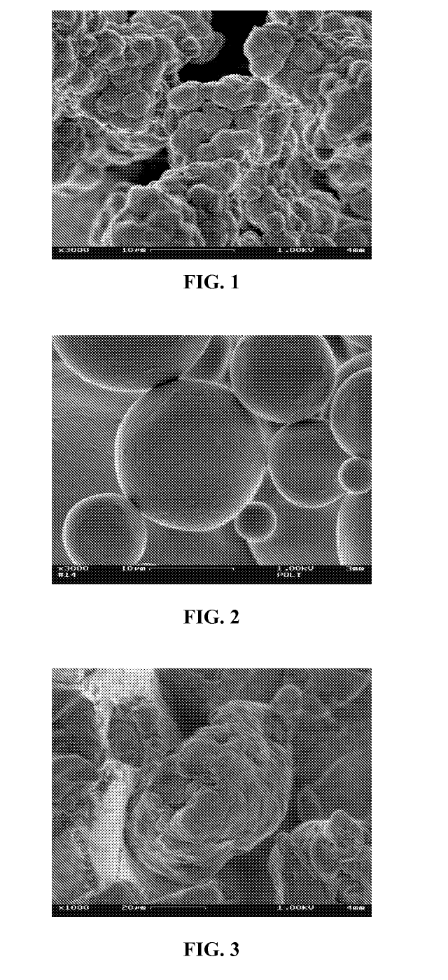

The efficiency of a filter aid for use according to the present invention is now illustrated in more detail. Three types of polyolefin particles have been used for filtration testing namely oxidized polyethylene having nodular structures at the surface (see FIG. 1), spherical oxidized polyethylene (see FIG. 2) and oxidized polyethylene as disclosed in EP1201288 (see FIG. 3) which presents micro defects at the outer surface.

FIG. 1 represents the outer surface of Inhance™ UH-1700, an oxidized ultrahigh molecular weight polyethylene (UHMWPE) having nodular structures at the outer surface. The presence of such structures creates micro or nanopores or micro or nano-void spaces that can retain yeast or colloidal particles.

FIG. 2 represents the outer surface of a spherical oxidized polyethylene. The surface of the material is smooth and does not present any defect, nodule or excrescence.

FIG. 3 represents the outer surface of an oxidized polyethylene as disclosed in EP1201288. The surface of the material presents micro defect due to the surface treatment (etched surface). No nodule nor excrescence can be observed at the outer surface of this material.

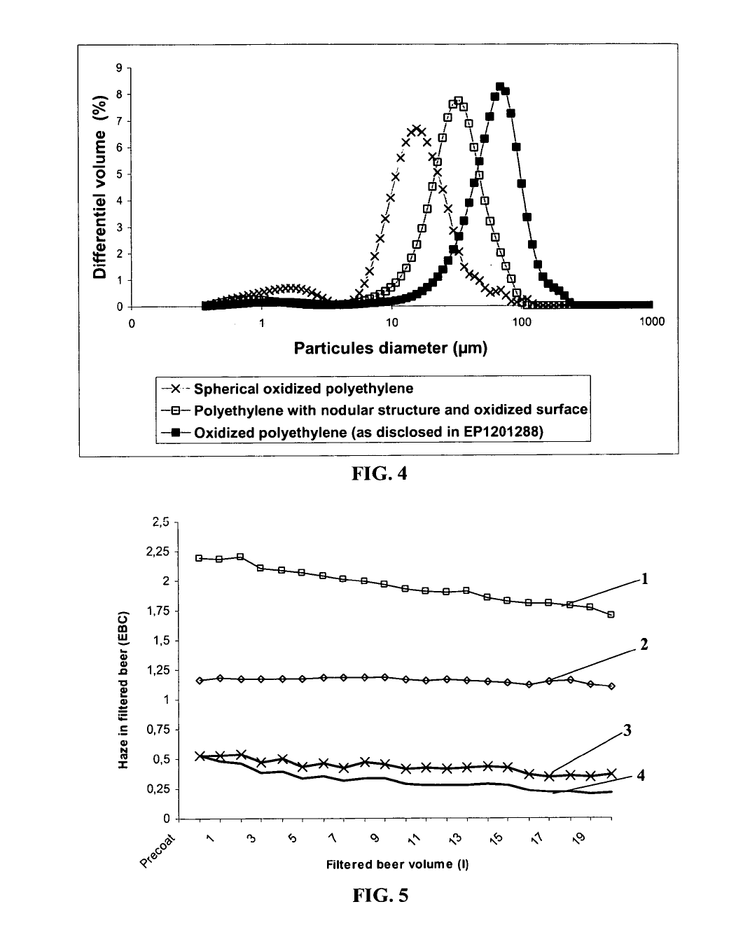

The size distribution of particles was measured by COULTER LS Particle Size Analyze (laser-based technology). The results are illustrated in FIG. 4. The average size of the spherical oxidized polyethylene particles (represented in FIG. 2) is 27 μm, The average size of the polyethylene particles having nodular structures at the outer surface (Inhance™ UH-1700) (represented in FIG. 1) is 37 μm, The average size of the oxidized polyethylene particles as disclosed in EP12012288 (represented in FIG. 3) is 69 μm.

The following examples illustrate results of filtration tests using filter aids in a beer filtration method according to an embodiment of the invention. Examples 1 and 4 have been performed using a filter aid made of particles of Inhance™ UH-1700, an UHMWPE having an oxidized outer surface and having nodular structures on its outer surface. Example 3 illustrates the use of a prior art filter aid. Example 2 has been performed using spherical oxidized polyethylene (Smooth surface without defects or nodules).

Filtration was performed on a candle filtration device with a single candle with a surface of 380 cm². The pre-coat was made of 2000 g/m² of filter, at a flow rate of 9.47 hl/h.m². During filtration, 2 g/l of filter aid was added to the beer for body feeding and the beer was filtered at a flow rate of 9.47 hl/h.m². For some assays, Brewtan® was added on unfiltered beer to show its effectiveness and PVPP was mixed with filter aid (25% PVPP-75% filter aid) for pre-coat and body feeding. Filtration trials were carried out with a beer having an initial haze matters content equal to 40/120 EBC (at 90° and 25°) and a yeast cells concentration equal to 5 million ufc/ml. Two different values are given by the hazemeter (Haffmans vos rota 90/25) depending on the diffraction angle: at 90° for the usual haze caused by particles with a size comprise between 0.1 and 1 μm, such as proteins, and at 25° for particles bigger than 1 μm such as filter aid particles or yeast cells.

### Example 1

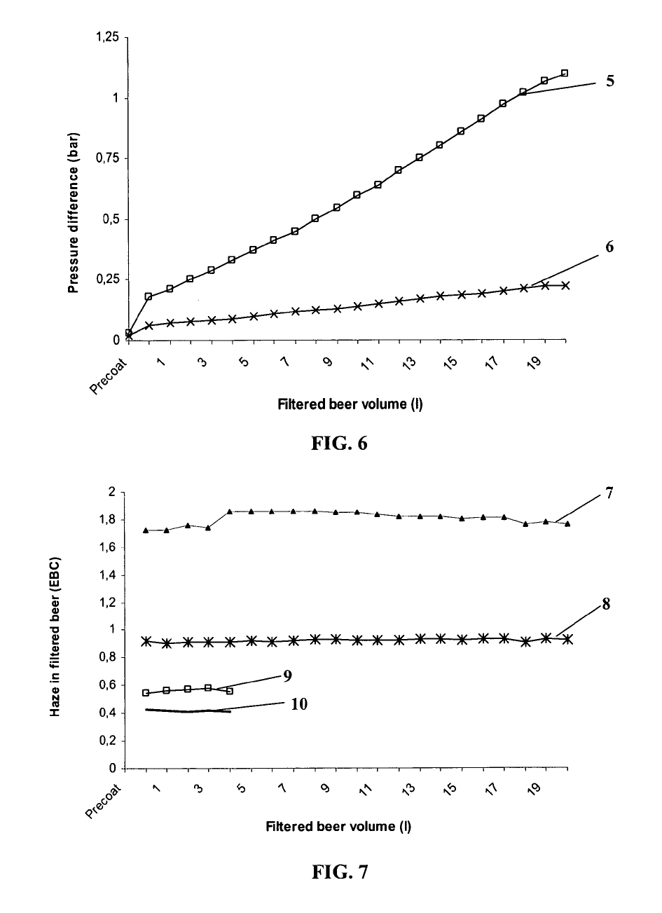

Experimental tests have been performed with a filter aid made of Inhance™ UH-1700, an UHMWPE having nodular structures at the outer surface and oxidized by oxyfluorination. The measured specific surface area of the filter aid was 1.386±0.02 m2/g. The FIG. 5 and FIG. 6 respectively show haze in filtered beer at 25° and 90° and the pressure difference within the filtration device as function of filtered beer volume using said filter aid. The outer surface of the used filter aid is presented in FIG. 1. The porosity of the filtration media formed with such particles is 0.6.

Curve 1 (FIG. 5) represents the haze value at 25° and curve 2 (FIG. 5) represents the haze at 90° when the filter aid is used. The haze at 25° slowly decreased from 2.25 to 1.75 EBC. The haze at 90° reached a constant value around 1.0 EBC.

Curve 3 (FIG. 5) represents the haze at 90° and curve 4 (FIG. 5) represents the haze at 25° when the filter aid having nodular structure was used in combination with protein complexing agent such as Brewtan® (2 g/hl). The haze reached 0.4 EBC at 90° (curve 3) while the haze at 25° reached 0.25 EBC (curve 4). This result clearly shows that the filter aid having nodular structures on its outer surface is particularly efficient for the filtration of liquid such as beer.

Curve 5 (FIG. 6) represents the pressure difference when the filter aid having nodular structure on its outer surface was used in combination with protein complexing agent such as Brewtan® (2 g/hl). Curve 6 (FIG. 6) represents the pressure difference when the filter aid having nodular structure on its outer surface was used alone.

The filter aid used in this example gave satisfying results in term of pressure difference in the candle filtration device. In addition, the filter aid also provides good results in term of haziness of the filtered liquid.

### Example 2

Experimental tests have been performed with a spherical oxidized polyethylene. Polyethylene was oxidized by surface treatment promoted by sodium hypochlorite (NaClO, 13% of active chlorine) at 80° C. with renewal of NaClO under aeration, two times during five hours. FIG. 7 and FIG. 8 respectively show haze in filtered beer at 25° and 90° and the pressure difference within the filtration device as function of filtered beer volume using said filter aid. The outer surface of the filter aid used in this example is presented in FIG. 2. The porosity of the filtration media formed with such particles is 0.35 in this example.

Curve 7 and 8 represent the haze in filtered beer at 25° and 90° respectively when spherical oxidized polyethylene was used. The haze reached values around 1.8 EBC (25°) and 0.95(90°) EBC. As shown in FIG. 8, the pressure difference raised to 0.8 bar at the end of the filtration process (Curve 12).

Curve 9 and 10 (FIG. 7) represent haze in filtered beer at an angle of 25° and 90° respectively when spherical oxidized polyethylene was used in combination with additives such as Brewtan® (2 g/hl). The haze values reached 0.6 EBC (25°) and 0.4 EBC (90°) . As showed in FIG. 8, the pressure difference increased too fast and raised 1.4 bar after having filtered only 5 liters (Curve 11).

When using the present filter aid, the pressure difference within the candle filtration device dramatically increased and therefore the candle device was completely clogged.

This example illustrates that a spherical oxidized polyethylene with a smooth outer surface i.e., without nodule or excrescence at the outer surface, is not suitable for the filtration of beer under industrial conditions.

### Example 3

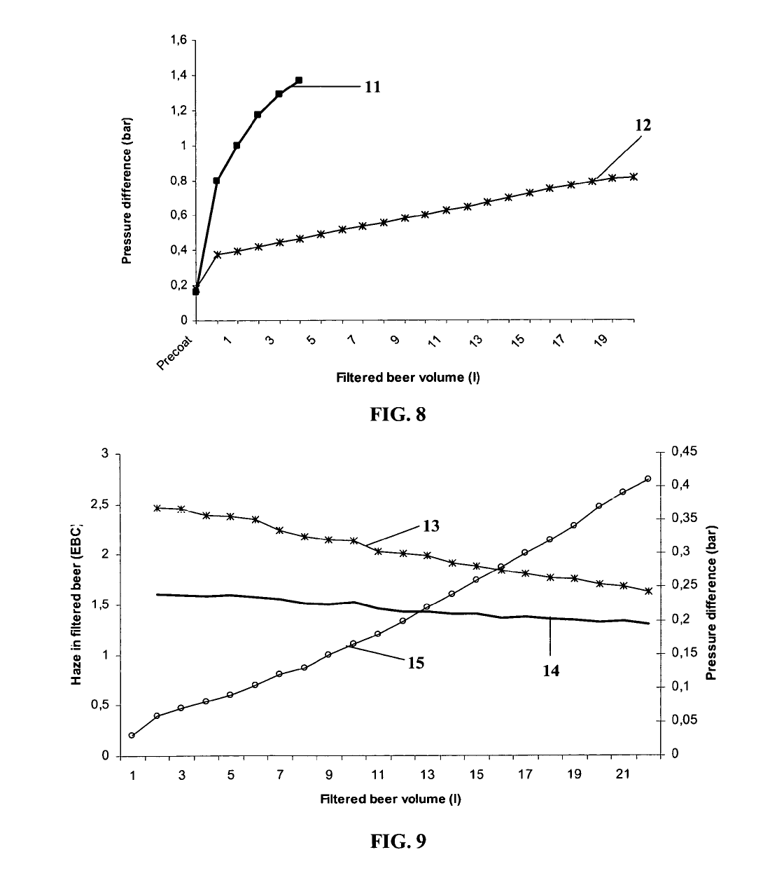

Experimental tests have been performed with an oxidized polyethylene as disclosed in EP1201288 in the previously mentioned conditions. FIG. 9 shows the haze in filtered beer at 25° and 90° and the pressure difference within the filtration device as function of filtered beer volume using said filter aid. The outer surface of the filter aid used in this example is presented in FIG. 3. The porosity of the filtration media formed with such polyolefin particles is 0.47.

Curve 13 and 14 (FIG. 9) represent the haze of filtered beer at an angle of 25° and 90° respectively. Haze values below 1.25 EBC could not be obtained when oxidized polyethylene as disclosed in EP1201288 was used. The pressure difference slowly increased (Curve 15, FIG. 9).

Performance in term of haziness when using a prior art filter aid of the present example is lower than the one obtained with a filter aid having nodular structures on its outer surface.

### Example 4

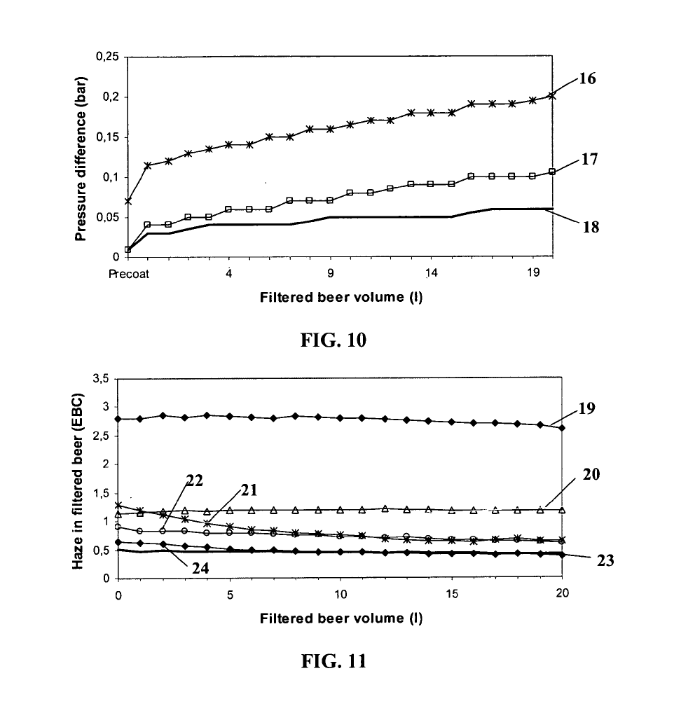

Experimental tests have been performed with Inhance™ UH-1700, a filter aid made of UHMWPE oxidized by oxyfluorination having nodular structures at the outer surface. FIG. 10 and FIG. 11 show the pressure difference within a filtration device and haze in filtered beer at 25° and 90° as function of filtered beer volume using said filter aid. The outer surface of the used filter aid is presented in FIG. 1. The porosity of the filtration media formed with such particles is 0.6.

Curve 16 (FIG. 10) represents the pressure difference when a mixture made of 75% of oxidized polyethylene having nodular structures at its outer surface and 25% of PVPP were used in combination with Brewtan® (1 g/hl).

Curve 17 (FIG. 10) represents the pressure difference when oxidized polyethylene having nodular structures at its outer surface was used in combination with Brewtan® (1 g/hl).

Curve 18 (FIG. 10) represents the pressure difference when oxidized polyethylene having nodular structures at its outer surface was used alone.

Curves 19 and 20 (FIG. 11) represent respectively haze at 25° and 90° when oxidized polyethylene having nodular structures at its outer surface was used alone.

Curves 21 and 24 (FIG. 11) represent respectively haze at 25° and 90° when oxidized polyethylene having nodular structures at its outer surface was used in combination with Brewtan® (1 g/hl). Haze reached value below 0.4 EBC.

Curves 22 and 23 (FIG. 11) represent respectively haze at 25° and 90° when a mixture made of 75% of oxidized polyethylene having nodular structures at its outer surface and 25% of PVPP were used in combination with Brewtan® (1 g/hl). A haze value below 0.4 EBC was obtained.

Having regard to examples 1, 2 and 4, it can be concluded that the presence of nodular structures at the outer surface of a filter aid comprising porous or non porous polyolefin particles has an important influence on haziness and pressure difference within a candle filtration device and therefore on brightness of filtered beer. Haze values decreased when nodular structures were present at the outer surface of said porous or non porous polyolefin particles and increased therefore when the specific surface area of the polyolefin particles as well as the porosity of the filtration media formed by said polyolefin particles increased.

### Example 5

Filter aid made of UHMWPE having nodular structure and an oxidized outer surface is prepared using GUR® UHMWPE micropowders having an average diameter of 20 μm. The powder material (200 g) is put in suspension in one liter of sodiumhypochloride 15%. The suspension is brought up to 91° C. during 17 h. The suspension is filtrated and the obtained filtrate is washed with demineralized water. This treatment renders the UHMWPE particles homogeneously divided over the total filtration surface of the candles of the filtration device.

The same experiment is repeated with GUR® UHMWPE micropowders having an average diameter of 30 μm and GUR® UHMWPE micropowders having an average diameter of 60 μm.

### Example 6

Filter aid made of UHMWPE having nodular structure and an oxidized outer surface is prepared in this example using GUR® UHMWPE micropowders having an average diameter of 20 μm. The micropowder material was surface treated with a gas stream comprising 2.5 volume % F₂: 81.5 volume % N₂: and 16 volume % O₂ at a temperature of 20° C., for ten min. This treatment renders the UHMWPE particles homogeneously divided over the total filtration surface of the candles of the filtration device.

The same experiment is repeated with GUR® UHMWPE micropowders having an average diameter of 30 μm and GUR® UHMWPE micropowders having an average diameter of 60 μm.

1. A method for filtering beer, comprising carrying out the filtration of said beer in the presence of a filter aid, wherein said filter aid essentially comprises porous or non porous UHMWPE particles having a specific mass less than 1000 kg/m³ and having an at least partly oxidized outer surface, whereby said outer surface is provided with nodular structures, wherein said nodular structures have an average diameter of 1 to 10 μm and wherein the specific surface area of the oxidized UHMWPE particles is at least 1 m²/g.

2. The method according to claim 1, wherein said polyolefin particles have a size distribution which is defined by an average diameter comprised between 20 and 300 μm.

3. (canceled)

4. The method according to claim 1, wherein the partly oxidized outer surface is obtained by chemical oxidation in the presence of KOCl, H₂O₂ or NaOCl solution, or by plasma treatment or by oxyfluorination process.

5. The method according to claim 1, wherein said polyolefin particles are grafted or modified UHMWPE particles.

6. The method according to claim 1, wherein said polyolefin has an average molecular weight ranging from 3 to 10.5 million g/mol, preferably from 3 to 5 million g/mol.

7. The method according to claim 1, wherein said UHMWPE particles are regenerated after filtration.

8. The method according to claim 1, wherein said polyolefin particles form a filtration medium, a granular medium or a filter cake having a porosity of at least 0.5.

9. The method according to claim 1, further comprising a complexing agent selected from the group comprising PVPP, gallotannin or tannic acids.

10. The method according to claim 1, wherein the filtered liquid has a haze value of less than 0.7 EBC when said filter aid is used in combination with a complexing agent selected from PVPP, gallotannin or a protein complexing agent.

11. The method according to claim 1, wherein said filtration is performed in a filtration device, preferably a candle filtration device.

12. The method according to claim 11, wherein said filter aid is provided in said device as a pre-coating material and/or as body feed simultaneously with an agent selected from PVPP, gallotannin or a protein complexing agent.
